(19) United States
(12) Patent Application Publication
(10) Pub. No.: US 2024/0258803 A1
(43) Pub. Date: Aug. 1, 2024

(54) CHARGING AND BALANCING BATTERIES

(71) Applicant: Apple Inc., Cupertino, CA (US)

(72) Inventors: Ashish K. Sahoo, Santa Clara, CA (US); Brandon Pierquet, San Francisco, CA (US); Matteo Telli, Pleasanton, CA (US)

(21) Appl. No.: 18/162,346

(22) Filed: Jan. 31, 2023

(51) Int. Cl. H02J 7/00; H02J 50/12; H02M 1/00; H02M 3/335

(52) U.S. Cl. CPC H02J 7/0019; H02J 50/12; H02M 1/0058; H02M 1/0095; H02M 3/33571

(57) ABSTRACT

A battery charging system can include a stacked half bridge rectifier (“SHBR”) having an upper half bridge (“UHB”) and a lower half bridge (“LHB”); a blocking capacitor and a winding coupled between a midpoint of the UHB and a midpoint of the LHB; a battery coupled across the SHBR; and control circuitry that can selectively operate the SHBR as a switched capacitor converter (“SCC”) using the blocking capacitor as a flying capacitor by alternating between: a first switching state in which lower switches of the UHB and LHB are closed while upper switches of the UHB and LHB are opened; and a second switching state in which upper switches of the UHB and LHB are closed. The battery can further include first and second series-connected batteries having a midpoint coupled to a midpoint of the SHBR, and the SCC can operate as a balancer to equalize charge between the batteries.

### BACKGROUND

As battery powered devices become more common, and the electrical demands on such devices increase, battery voltages may be increased to provide increased energy storage capacity as well as increased efficiency. As but one example, the electric vehicle industry is moving towards higher battery voltages (e.g., 800V) to attain high efficiencies. This can be implemented as a single 800V battery or two (or more) lower voltage batteries (e.g., 2× 400V) connected in series. Such configurations are not limited to electric vehicle applications and can be used in various other applications, such as grid storage, etc. Nonetheless, the principles are even applicable in the case of consumer electronic devices, in which a low voltage source (e.g., 5 VDC from an AC adapter or battery bank) is desired to charge a battery having a higher voltage in a personal electronic device. In some cases, stacked half-bridge power converters can be used, implemented with devices (semiconductor switching devices, capacitors, etc.) having lower voltage ratings, e.g., equal to one-half the battery voltage.

Conventional approaches use a boost converter to match the lower available charging voltage to a higher battery voltage. For battery systems including multiple batteries, a balancer power converter may also be needed to balance the energy between the batteries. Systems with split batteries also need a way to charge while also balancing the batteries and may therefore use an additional dedicated power converter as balancer. These conventional approaches add cost, complexity, and mass to the overall system as well as consuming extra space.

### SUMMARY

Thus, it would be desirable to provide a new architecture and switching states of an existing charger to meet the above needs while eliminating the need of an additional power converter to provide the balancing and/or boosting functions.

A battery charging system can be constructed to charge a battery from an AC source, a first DC source with a higher voltage than the battery, and a second DC source having a voltage lower than the battery. The battery charging system can include an inverter having an input coupled to the AC source; a transformer having a primary winding coupled to an output of the inverter and a secondary winding; a stacked half bridge rectifier having an input coupled to the secondary winding by a blocking capacitor and an output coupled to the battery; one or more contactors selectively coupling a DC input that receives power from the first or second DC source to the battery and a midpoint of the stacked half bridge rectifier; and control circuitry that can selectively operate the one or more contactors and switching devices of the stacked half bridge rectifier as a switched capacitor booster using the blocking capacitor as a flying capacitor to charge the battery from the second DC source. The inverter can be a stacked half bridge inverter, and the control circuitry can selectively operate switching devices of the stacked half bridge inverter to short circuit the primary winding of the transformer when operating the stacked half bridge rectifier as a switched capacitor booster.

The control circuitry can selectively operate switching devices of the stacked half bridge inverter to short circuit the primary winding of the transformer using a switching mode including one or more of: a first switching mode including closing a lower switch of an upper half bridge and an upper switch of a lower half bridge while opening an upper switch of the upper half bridge and a lower switch of the lower half bridge; a second switching mode including closing the upper switch of the upper half bridge and the lower switch of the lower half bridge while opening the lower switch of the upper half bridge and the upper switch of the lower half bridge; and a third switching mode including closing both switches of the upper half bridge and both switches of the lower half bridge. Each of the first, second, and third switching modes can further include alternating between: a first switching state in which lower switches of the upper and lower half bridges of the rectifier are closed while upper switches of the upper and lower half bridges are opened to charge the blocking capacitor as a flying capacitor of the switched capacitor booster; and a second switching state in which upper switches of the upper and lower half bridges of the rectifier are closed to discharge the flying capacitor into the battery. A frequency of alternating between the first switching state and the second switching state can be controlled to achieve soft switching using energy stored in an inductance that resonates with the flying capacitor. The inductance can include a leakage inductance of the transformer and/or a discrete inductor. The control circuitry can selectively operate switching devices of the stacked half bridge inverter to short circuit the primary winding of the transformer by alternating between two or more of the first, second, or third switching modes.

The control circuitry can selectively operate a contactor to short circuit a winding of the transformer using a switching mode including one or more of: a fourth switching mode including using a contactor to short circuit a primary winding of the transformer; and a fifth switching mode including using a contactor to short circuit a secondary winding of the transformer. Each of the fourth and fifth switching modes can further include alternating between: a first switching state in which lower switches of the upper and lower half bridges of the rectifier are closed while upper switches of the upper and lower half bridges are opened to charge the blocking capacitor as a flying capacitor of the switched capacitor booster; and a second switching state in which upper switches of the upper and lower half bridges of the rectifier are closed to discharge the flying capacitor into the battery.

The transformer can be part of a wireless power transfer system in which the primary winding is a wireless power transmitter winding, and the secondary winding is a wireless power receiver winding. The control circuitry can selectively operate in a sixth switching mode comprising alternating between: a first switching state in which lower switches of the upper and lower half bridges of the rectifier are closed while upper switches of the upper and lower half bridges are opened to charge the blocking capacitor as a flying capacitor of the switched capacitor booster; and a second switching state in which upper switches of the upper and lower half bridges of the rectifier are closed to discharge the flying capacitor into the battery.

A battery charging system can include a stacked half bridge rectifier having an upper half bridge and a lower half bridge; a blocking capacitor and a winding coupled between a midpoint of the upper half bridge and a midpoint of the lower half bridge; a battery coupled between an upper terminal of the upper half bridge and a lower terminal of the lower half bridge; and control circuitry that can selectively operate the stacked half bridge rectifier as a switched capacitor converter using the blocking capacitor as a flying capacitor by alternating between: a first switching state in which lower switches of the upper and lower half bridges of the rectifier are closed while upper switches of the upper and lower half bridges are opened; and a second switching state in which upper switches of the upper and lower half bridges of the rectifier are closed; wherein the switched capacitor converter operates as a booster to charge the battery from a DC voltage source having a voltage lower than a voltage of the battery. A frequency of alternating between the first switching state and the second switching state can be controlled to achieve soft switching using energy stored in the winding, which resonates with the flying capacitor. The winding can be a winding of a transformer; a wireless power receiver winding; and/or a discrete inductor.

A power converter can include a stacked half bridge converter having an upper half bridge and a lower half bridge; a capacitor and an inductance coupled between a switch node of the upper half bridge and a switch node of the lower half bridge; an output coupled across the stacked half bridge; and control circuitry that can selectively operate the stacked half bridge converter as: a rectifier to produce an output DC voltage from an input AC voltage received via the capacitor and inductance; or a switched capacitor converter using the capacitor as a flying capacitor to boost a DC input voltage coupled to the junction of the upper half bridge and lower half bridge to produce the DC output voltage by alternating between: a first switching state in which lower switches of the upper and lower half bridges of the converter are closed while upper switches of the upper and lower half bridges of the converter are opened; and a second switching state in which upper switches of the upper and lower half bridges of the converter are closed. A frequency of alternating between the first switching state and the second switching state can be controlled to achieve soft switching using energy stored in a resonant circuit including the capacitor and the inductance. The inductance can include a winding of a transformer, a wireless power receiver winding, and/or a discrete inductor.

A battery charging system can be constructed to charge first and second series-connected batteries from an AC source, a first DC source with a higher voltage than the series-connected batteries, and a second DC source having a voltage lower than the series-connected batteries. The battery charging system can include an inverter having an input coupled to the AC source; a transformer having a primary winding coupled to an output of the inverter and a secondary winding; a stacked half bridge rectifier having an input coupled to the secondary winding by a blocking capacitor and an output coupled to the battery; one or more contactors selectively coupling a DC input that receives power from the first or second DC source to the series-connected batteries and a midpoint of the stacked half bridge rectifier; and control circuitry that can selectively operate the one or more contactors and switching devices of the stacked half bridge rectifier as a switched capacitor balancer using the blocking capacitor as a flying capacitor to equalize charge between the first and second series-connected batteries. The inverter can be a stacked half bridge inverter, and the control circuitry can selectively operate switching devices of the stacked half bridge inverter to short circuit the primary winding of the transformer when operating the stacked half bridge rectifier as a switched capacitor balancer.

The control circuitry can selectively operate switching devices of the stacked half bridge inverter to short circuit the primary winding of the transformer using a switching mode comprising one or more of: a first switching mode including closing a lower switch of an upper half bridge and an upper switch of a lower half bridge while opening an upper switch of the upper half bridge and a lower switch of the lower half bridge; a second switching mode including closing the upper switch of the upper half bridge and the lower switch of the lower half bridge while opening the lower switch of the upper half bridge and the upper switch of the lower half bridge; and a third switching mode including closing both switches of the upper half bridge and both switches of the lower half bridge. Each of the first, second, and third switching modes can further include alternating between: a first switching state in which lower switches of the upper and lower half bridges of the rectifier are closed while upper switches of the upper and lower half bridges are opened; and a second switching state in which upper switches of the upper and lower half bridges of the rectifier are closed. In one of the first or second switching states the flying capacitor is charged from a battery of the first and second series-connected batteries having a higher state of charge and in another of the first or second switching states the flying capacitor is discharged into a battery of the first and second series-connected batteries having a lower state of charge. A frequency of alternating between the first switching state and the second switching state can be controlled to achieve soft switching using energy stored in an inductance that resonates with the flying capacitor. The inductance can include a leakage inductance of the transformer and/or a discrete inductor. The control circuitry can selectively operate switching devices of the stacked half bridge inverter to short circuit the primary winding of the transformer by alternating between two or more of the first, second, or third switching modes.

The control circuitry can selectively operate a contactor to short circuit a winding of the transformer using a switching mode including one or more of: a fourth switching mode including using a contactor to short circuit a primary winding of the transformer; and a fifth switching mode including using a contactor to short circuit a secondary winding of the transformer. Each of the fourth and fifth switching modes can further include alternating between: a first switching state in which lower switches of the upper and lower half bridges of the rectifier are closed while upper switches of the upper and lower half bridges are opened; and a second switching state in which upper switches of the upper and lower half bridges of the rectifier are closed; wherein in one of the first or second switching states the flying capacitor can be charged from a battery of the first and second series-connected batteries having a higher state of charge and in another of the first or second switching states the flying capacitor can be discharged into a battery of the first and second series-connected batteries having a lower state of charge.

The transformer can be part of a wireless power transfer system in which the primary winding is a wireless power transmitter winding, and the secondary winding is a wireless power receiver winding. The control circuitry can selectively operate in a sixth switching mode that includes alternating between: a first switching state in which lower switches of the upper and lower half bridges of the rectifier are closed while upper switches of the upper and lower half bridges are opened; and a second switching state in which upper switches of the upper and lower half bridges of the rectifier are closed; wherein in one of the first or second switching states the flying capacitor can be charged from a battery of the first and second series-connected batteries having a higher state of charge and in another of the first or second switching states the flying capacitor can be discharged into a battery of the first and second series-connected batteries having a lower state of charge.

A battery charging system can include a stacked half bridge rectifier having an upper half bridge and a lower half bridge; a blocking capacitor and a winding coupled between a midpoint of the upper half bridge and a midpoint of the lower half bridge; a battery coupled between an upper terminal of the upper half bridge and a lower terminal of the lower half bridge; and control circuitry that can selectively operate the stacked half bridge rectifier as a switched capacitor converter using the blocking capacitor as a flying capacitor by alternating between: a first switching state in which lower switches of the upper and lower half bridges of the rectifier are closed while upper switches of the upper and lower half bridges are opened; and a second switching state in which upper switches of the upper and lower half bridges of the rectifier are closed. The battery can further include first and second series-connected batteries having a midpoint coupled to a midpoint of the stacked half bridge rectifier, and the switched capacitor converter can operate as a balancer to equalize charge between the first and second series-connected batteries. A frequency of alternating between the first switching state and the second switching state can be controlled to achieve soft switching using energy stored in the winding, which resonates with the flying capacitor. The winding can be a winding of a transformer, a wireless power receiver winding, and/or a discrete inductor.

A power converter can include a stacked half bridge converter having an upper half bridge and a lower half bridge; a capacitor and an inductance coupled between a switch node of the upper half bridge and a switch node of the lower half bridge; a first output coupled across the upper half bridge and a second output coupled across the lower half bridge; and control circuitry that can selectively operate the stacked half bridge converter as: a rectifier to produce output DC voltages from an input AC voltage received via the capacitor and inductance; or a switched capacitor converter using the capacitor as a flying capacitor to balance the output DC voltages by alternating between: a first switching state in which lower switches of the upper and lower half bridges of the converter are closed while upper switches of the upper and lower half bridges of the converter are opened; and a second switching state in which upper switches of the upper and lower half bridges of the converter are closed; wherein the switched capacitor converter operates as a booster to charge the battery from a DC voltage source having a voltage lower than a voltage of the battery. A frequency of alternating between the first switching state and the second switching state is controlled to achieve soft switching using energy stored in a resonant circuit including the capacitor and the inductance. The inductance can include a winding of a transformer, a wireless power receiver winding, and/or a discrete inductor.

### BRIEF DESCRIPTION OF THE DRAWINGS

FIG. 1 illustrates a charging circuit configuration for charging dual batteries from an AC grid.

FIG. 2 illustrates an arrangement for charging a battery from either an AC grid or a DC charger.

FIG. 3A illustrates an improved arrangement for charging a battery from either an AC grid or a DC charger in which a rectifier stage can be used as a switched capacitor booster.

FIG. 3B illustrates an equivalent circuit of the rectifier stage used as a switched capacitor booster.

FIG. 3C illustrates control circuitry of an improved arrangement for charging a battery from either an AC grid or a DC charger in which a rectifier stage can be used as a switched capacitor booster.

FIG. 4A-4F respectively illustrate six different switching modes in which a rectifier stage is used as a switched capacitor booster, each switching mode having respective first and second switching states.

FIG. 5A illustrates an improved arrangement for charging a dual battery system from either an AC grid or a DC charger in which a rectifier stage can be used as a switched capacitor balancer.

FIG. 5B illustrates an alternative configuration of improved arrangement for charging a dual battery system from either an AC grid or a DC charger in which a rectifier stage can be used as a switched capacitor balancer.

FIG. 5C illustrates an equivalent circuit of the rectifier stage used as a switched capacitor balancer.

FIG. 5D illustrates control circuitry of an improved arrangement for charging a dual battery system from either an AC grid or a DC charger in which a rectifier stage can be used as a switched capacitor booster.

FIGS. 6A-6F respectively illustrate six different switching modes in which a rectifier stage is used as a switched capacitor balancer, each switching mode having respective first and second switching states.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

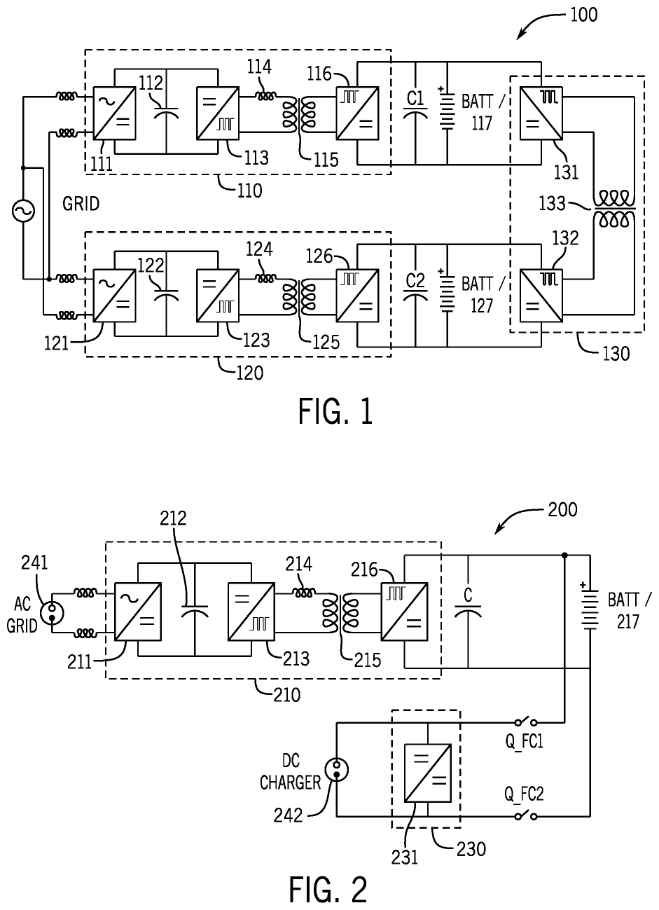

FIG. 1 illustrates a first charging circuit configuration 100 for charging a dual battery system from an AC grid. More specifically, a first battery 117 is charged by a first charger 110, and a second battery 127 is charged by a second charger 120. Chargers 110/120 can be connected to an AC Grid power source. Each charger can include a respective rectifier 111/121 that generates a DC voltage bus supported by respective capacitors 112/122. The rectifiers can be active or passive, made up of suitable semiconductor switching devices, such as diodes, silicon controlled rectifiers (SCRs), thyristors, or transistors, such as metal oxide semiconductor field effect transistors (MOSFETs) or insulated gate bipolar transistors (IGBTs), etc. The semiconductor devices can be implemented using any suitable semiconductor technology, such as silicon (Si), silicon carbide (SiC), gallium nitride (GaN), etc.

The DC voltages produced by the respective rectifiers 111/121 can be provided to respective inverters 113/123. Inverters 113/123 can be implemented using any suitable topology and any suitable semiconductor switching devices, including those described above. Control circuitry (not shown) can control switching of such switching devices to produce a desired battery charging voltage, e.g., by pulse width modulation (PWM). The output AC power from inverters 113/123 can be supplied to respective rectifiers 116/126 via respective filter inductors 114/124 and transformers 115/125. Transformers 115/125 can step the AC voltage from the inverter up or down as desired for a particular application. Additionally, in some applications, the filter inductors 114/124 can be implemented using the leakage inductances of the respective transformers, and thus not necessarily a discrete physical inductor.) Respective rectifiers 116/126 can produce respective DC battery charging voltages at their output, supported by respective capacitors C1/C2 and supplied to batteries 117/127. Rectifiers 116/126 can also be active or passive rectifiers made up of suitable semiconductor switching devices, such as those described above.

Additionally, charge of the respective batteries 117/127 can be equalized by balancer circuitry 130. Balancer circuitry 130 can include two bidirectional converters 131/132, which can be PWM inverters/rectifiers. These may employ a variety of topologies as well as a variety of semiconductor device types, such as those described above. The DC sides of the respective bidirectional converters 131/132 can be coupled to batteries 117/127, and the AC sides of the respective bidirectional converters can be coupled together, e.g., by transformer 133, which can provide galvanic isolation between the two batteries. Control circuitry (not shown) can control switching of the bidirectional converters 131/132 to transfer power from one battery to the other, thereby equalizing the charge between them.

FIG. 2 illustrates an arrangement 200 for charging a battery from either an AC grid 241 or a DC charger 242. To charge from the AC grid, battery 217 receives power from AC grid 241 via a charger 210, which may be constructed and operated as with chargers 110/120 described above with respect to FIG. 1. Alternatively, a DC power source 242 may be coupled to a DC charger 230 including suitable DC-DC converter 231. DC-DC converter 231 can be constructed from any suitable topology to convert the input DC voltage from DC charger 242 into a suitable voltage for charging battery 217. For example, if the DC voltage provided by DC charger 242 is less than the battery voltage, DC-DC converter 231 can be a boost converter or other suitable converter type for stepping up the supplied voltage. DC-DC converter can be constructed using any suitable topology and any suitable semiconductor devices, including those described above. Control circuitry, not shown, can operate the semiconductor devices to produce the desired output voltage form the available input voltage, as required. In some applications, a contactor Q_FC1/Q_FC2 may be provided to selectively connect or disconnect the DC power source and booster 230 from battery 217. This contactor may be a mechanical contactor or relay or a suitable semiconductor switching arrangement, depending on the requirements of a particular system.

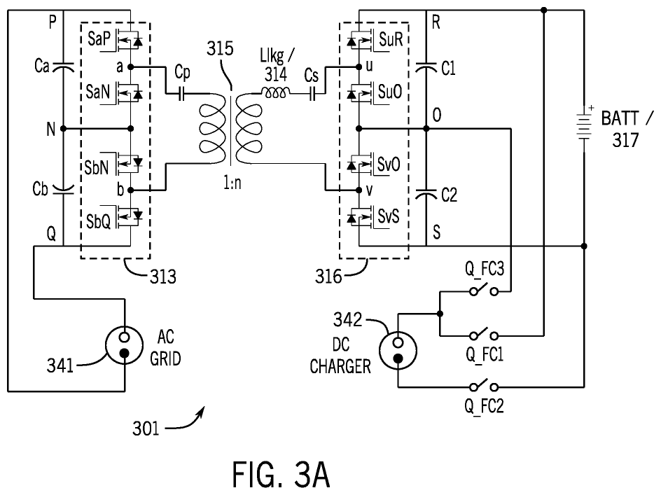

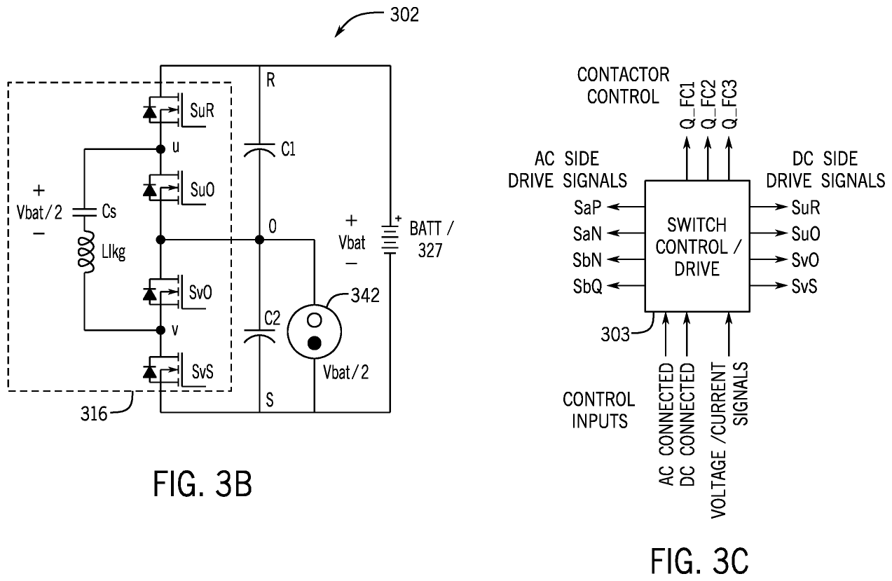

FIG. 3A illustrates an improved circuit arrangement 301 for charging a battery 317 from either an AC grid 341 or a DC charger 342 in which a rectifier stage 316 can be used as a switched capacitor booster. Beginning on the AC side of circuit arrangement 301, AC grid 341 is coupled to inverter 313, which can generally correspond to inverter 113/123/213 as described above. Inverter 313 can be a stacked half bridge topology including a first half bridge and a second half bridge. The first half bridge can include switches SaP and SaN connected as shown between AC line P and neutral N. The second half bridge can include switches SbN and SbQ connected as shown between AC line Q and neutral N. Input capacitors Ca and Cb can be coupled across the respective half bridges.

The switch node of the first half bridge (i.e., node a) can be coupled to the primary winding of transformer 315 via a blocking capacitor Cp. Similarly, the switch node of the second half bridge (i.e., node b) can also be coupled to the primary winding of transformer 315. Transformer 315 can have a turns ratio of 1:n to produce a desired output voltage. Transformer 315 can also include a leakage inductance Llkg/314, represented schematically as shown, although this need not be a discrete inductor but rather a property of the transformer itself. Alternatively, in some embodiments, a discrete “leakage” inductor can be provided if necessary to supply a desired inductance.

The secondary winding of transformer 315 can be coupled to rectifier 316, which can generally correspond to rectifier 116/126/216 as described above. More specifically, rectifier 316 can be constructed using a stacked half bridge topology, with a first half bridge and a second half bridge. The first half bridge can include switches SuR and SuO connected between positive battery terminal R and midpoint terminal O as shown. The second half bridge can include switches SvO and SvS connected between midpoint terminal O and negative battery terminal S as shown. The switch node u of the first half bridge can be coupled to the secondary winding of transformer 315 via blocking capacitor Cs (and leakage inductance Llkg/314, although, as noted, the leakage inductance need not be a discrete component). Similarly, the switch node v of the second half bridge can also be coupled to the secondary winding of transformer 315. Filter capacitors C1 and C2 may be connected across the DC sides of the rectifier half bridges as illustrated.

With continued reference to the DC side of circuit arrangement 301, a DC charger 342 can be selectively coupled to battery 317 via contactor Q_FC1/Q_FC2/Q_FC3, which can generally correspond to the contactor discussed above with respect to FIG. 2, although it will be noted that an additional contact (Q_FC3) is provided. If DC charger 342 can provide a DC voltage high enough to charge battery 317, then Q_FC1 and Q_FC2 can be closed (with Q_FC3 open), allowing for direct DC charging. Otherwise, if DC charger 342 provides a voltage lower than that needed to charge battery 317, then contacts Q_FC3 and Q_FC2 can be closed, coupling the DC charger 342 to node O, the midpoint of the stacked half bridge rectifier 316, which can be operated as a switched capacitor converter as described further below to boost the DC voltage from charger 342 to a level sufficient to charge battery 317.

FIG. 3B illustrates an equivalent circuit 302 of the rectifier stage 316 used as a switched capacitor booster. In this mode, the primary winding of transformer 315 can be short circuited by various means (described in greater detail below), so that the DC side of the circuit functions as a switched capacitor booster. More specifically, rectifier switching devices SuR, SuO, SvO, and SvS can be operated by control circuitry 303 to selectively couple blocking capacitor Cs, which acts as the flying capacitor of the switched capacitor booster, in parallel with the DC charger 342, thereby charging the capacitor, and in series with the DC charger, thereby discharging the capacitor into battery 317. Basic operation of switched capacitor converters is known to those skilled in the art, and results in an average voltage of approximately Vbat/2 across the flying capacitor Cs. In series with the DC charger 342, which can also provide a voltage of Vbat/2, this provides a voltage Vbat, suitable for charging battery 317.

FIG. 3C illustrates control circuitry 303 of an improved arrangement for charging a battery from either an AC grid 341 or a DC charger 342 in which a rectifier stage 316 can be used as a switched capacitor booster. Control circuitry 303 can be implemented using any suitable combination of analog, digital, or programmable circuitry, implementing such functions as error amplifiers, comparators, logic gates, delays, storage, programmable functionality, microcontrollers, microprocessors, etc. This circuitry can be implemented using any suitable combination of discrete circuit elements, integrated circuits, etc. Control circuitry 303 can receive a variety of inputs, including indications whether the AC charging circuitry is connected to an AC grid 341, whether the DC charging circuitry is connected to a DC charger 342, and voltage/current signals, such as the voltage of the supplied AC and/or DC voltages and/or supplied or available input currents; output voltages and supplied, required, or desired output currents; and one or more intermediate voltages, currents, or other signals (temperature, etc.). Although described as a single controller, control circuitry 303 could be implemented as multiple controllers each providing certain functionality. In such cases, communication between the various control circuits/controllers can be provided as necessary or desirable to provide the desired overall operation and/or the various separate control circuits can operate independently to the extent possible or desirable.

Control circuitry 303 can also implement one or more control loops and/or program logic to generate the signals needed to control various components of the system. For example, AC side drive signals may be provided to control the operation of switches SaP, SaN, SbN, and SbQ depending on the operating mode and other parameters. For example, when charging from an AC source 341 these switches can be operated to provide a desired voltage to transformer 315 corresponding to a desired battery charging voltage. When charging from a DC charger 342 that can supply an adequate voltage to charge the battery, these switches can be turned off. When charging from a DC charger 342 that cannot supply an adequate voltage to charge the battery, these switches can be operated to short circuit the primary winding of transformer 315 as described in greater detail below.

Likewise, control circuitry 303 can provide DC side control/drive signals to control the operation of switches SuR, SuO, SvO, and SvS depending on the operating mode and other parameters. For example, when charging from an AC source 341, these switches can be operated as an active rectifier to produce a DC charging voltage from the AC voltage appearing across the secondary winding of transformer 315. When charging from a DC charger 342 that can supply an adequate voltage to charge the battery, these switches can be turned off. When charging from a DC charger 342 that cannot supply an adequate voltage to charge the battery, these switches can be operated to act as a switched capacitor converter as described in greater detail below.

Additionally, control circuitry 303 can provide contactor control signals Q_FC1, Q_FC2, and Q_FC3 to control the contactor described above. For example, when charging from an AC source 341, these contactors can be open. When charging from a DC charger 342 that can supply an adequate voltage to charge battery 317, contactors Q_FC1 and Q_FC2 can be closed, as described above. When charging from a DC charger 342 that cannot supply an adequate voltage to charge battery 317, contactors Q_FC3 and Q_FC2 can be closed, as described above.

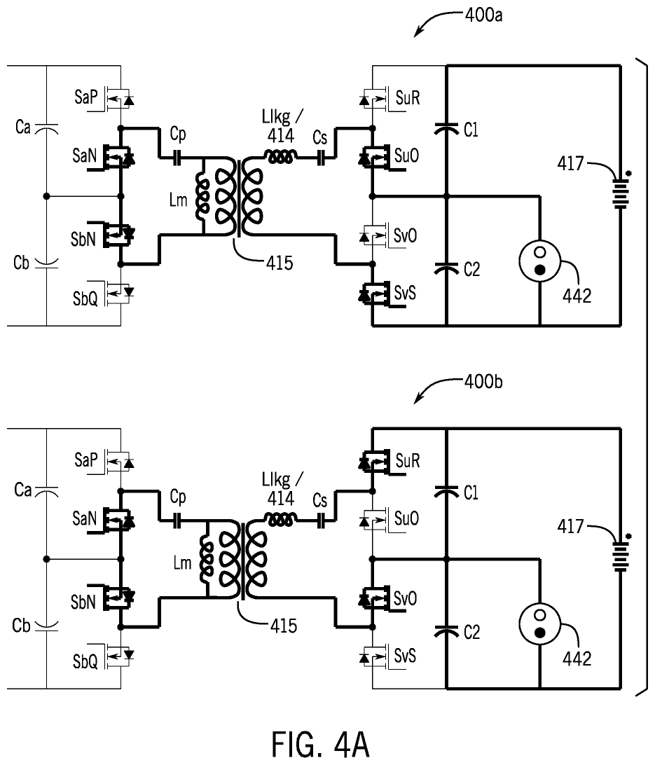

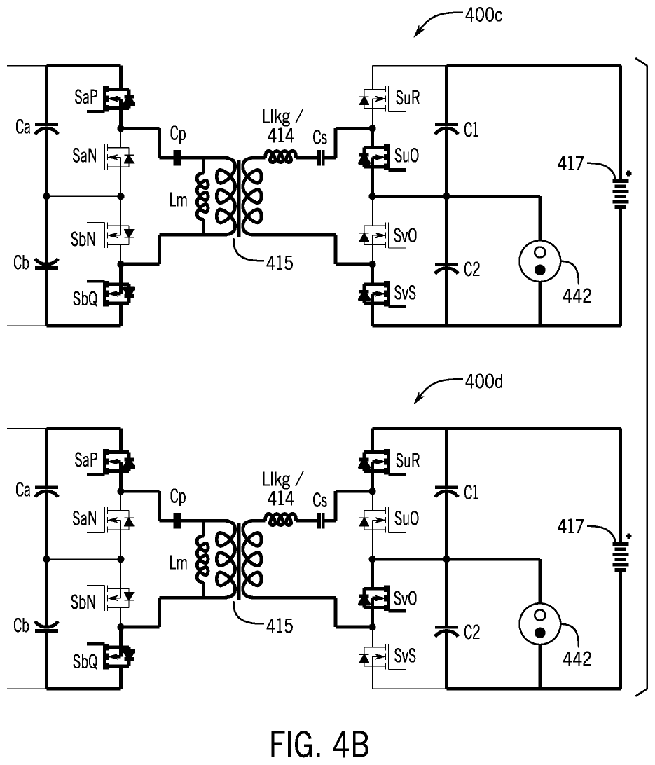

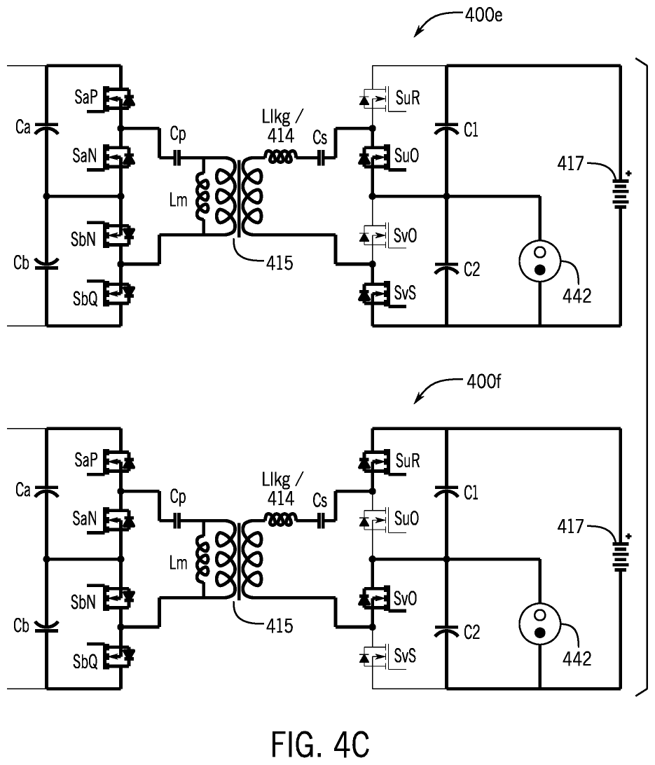

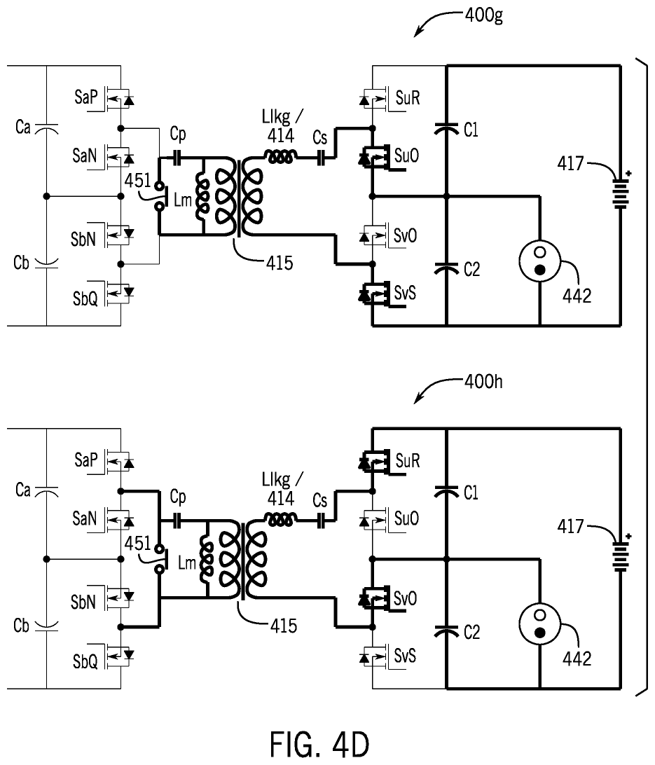

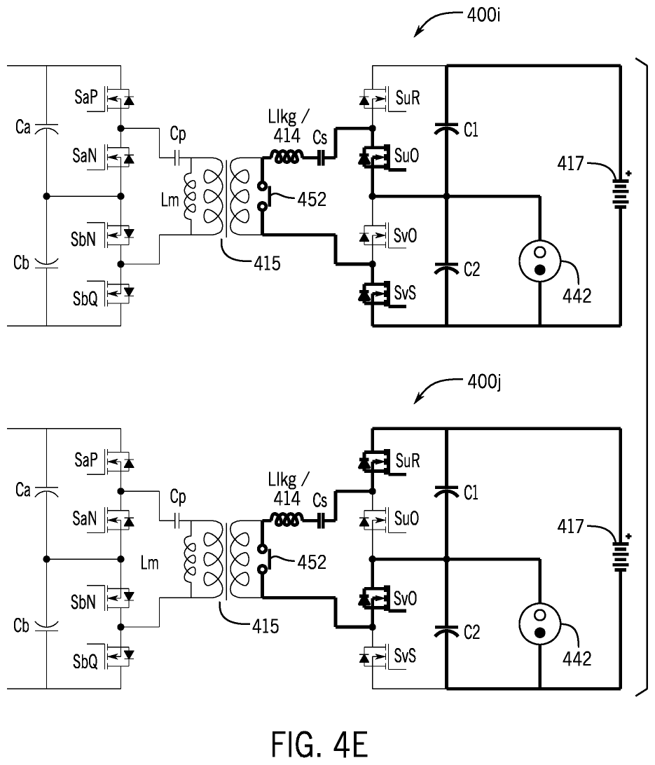

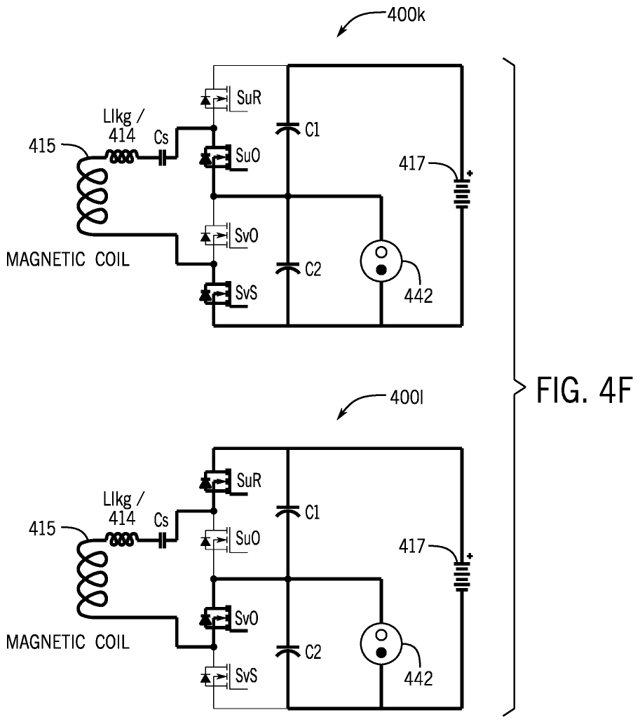

FIG. 4A illustrates a first switching mode in which a rectifier stage is used as a switched capacitor booster, the first switching mode having a first switching state 400a and a second switching state 400b. The first switching mode can be characterized by the way the primary winding of transformer 415 is short circuited, i.e., by closing switches SaN and SbN while switches SaP and SbQ remain open. Magnetizing inductance Lm of transformer 415 is also depicted for completeness. In first switching state 400a, switches SuO and SvS are closed, and switches SuR and SvO are opened. This effectively connects flying capacitor Cs (also used as a blocking capacitor in other modes) in parallel with DC charger 442. This allows flying capacitor Cs to charge from the DC input source to approximately the same voltage as the DC input source. Additionally, capacitor C2 is connected in parallel with DC charger 442, thus being charged to the same voltage. Capacitor C1, having previously been connected in parallel with flying capacitor Cs is also charged to approximately the DC input voltage. Thus, in first switching state 400a, the series combination of capacitors C1 and C2 presents 2 times the input voltage to battery 417.

In second switching state 400b, switches SuO and SvS are opened, and switches SuR and SvO are closed. In other words, as between the two switching states, the switches of each half bridge (i.e., switches SuR and SuO of the first half bridge and switches SvO and SvS of the second half bridge) are operated complementarily. This effectively connects flying capacitor Cs (also used as a blocking capacitor in other modes) in series with DC charger 442 and across battery 417. This allows flying capacitor Cs to discharge while suppling twice the input voltage to the battery. Additionally, capacitor C2 is connected in parallel with DC charger 442, thus being charged to the same voltage. Capacitor C1, is connected in parallel with flying capacitor Cs and is therefore also charged to approximately the DC input voltage. Thus, in second switching state 400b, the series combination of DC charger 442 and flying capacitor Cs (and also capacitors C1 and C2) presents twice the input voltage to battery 417.

Alternating between first and second switching states 400a/400b can thus effectively boost the input voltage received from DC charger 442 two times, thus allowing for a high voltage battery to be charged from a lower voltage DC source without requiring an additional boost circuit. The frequency/timing of the alternation between the respective switching states can be controlled to achieve soft switching by using the energy stored in leakage inductance Llkg/414, thereby improving the operating efficiency of the circuit.

FIG. 4B illustrates a second switching mode in which a rectifier stage is used as a switched capacitor booster, the second switching mode having a first switching state 400c and a second switching state 400d. The second switching mode can be characterized by the way the primary winding of transformer 415 is short circuited, i.e., by closing switches SaP and SbQ while switches SaN and SbN remain open. This configuration is complementary to the configuration discussed above with respect to FIG. 4A but is otherwise effectively equivalent at the PWM switching frequency, which can be substantially higher than the AC line frequency. In other words, the relatively large capacitance of input capacitors Ca/Cb can be seen as effectively a short circuit at the higher PWM switching frequency. In some applications it may be desirable to alternate between the first and second switching modes to equalize the thermal load as between the AC side switching devices. The first switching mode may be preferred in some applications, as the second switching mode may energize the AC terminals, which may or may not be appropriate in some applications. Alternatively, additional isolation for the AC input terminals could be provided, for example in the form of an isolation or disconnect switch, which could be implemented as a solid-state and/or mechanical switching arrangement. Otherwise, the DC side operation of the second switching mode can be as generally as described above with respect to the first switching mode, with switching state 400c generally corresponding to switching state 400a and switching state 400d generally corresponding to switching state 400b.

FIG. 4C illustrates a third switching mode in which a rectifier stage is used as a switched capacitor booster, the third switching mode having a first switching state 400e and a second switching state 400f. The third switching mode can be characterized by the way the primary winding of transformer 415 is short circuited, i.e., by closing switches all of switches SaP, SaN, SbQ, and SbN. This configuration is effectively the combination of the configurations discussed above with respect to FIGS. 4A and 4B but is otherwise effectively equivalent at the PWM switching frequency, which can be substantially higher than the AC line frequency. In other words, the relatively large capacitance of input capacitors Ca/Cb can be seen as effectively a short circuit at the higher PWM switching frequency. In some applications it may be desirable to alternate between the first, second, and/or third switching modes to equalize the thermal load as between the AC side switching devices. The first switching mode may be preferred in some applications, as the second switching mode may energize the AC terminals, which may or may not be appropriate in some applications. Alternatively, additional isolation for the AC input terminals could be provided, for example in the form of an isolation or disconnect switch, which could be implemented as a solid-state and/or mechanical switching arrangement. Otherwise, the DC side operation of the third switching mode can be as generally as described above with respect to the first switching mode, with switching state 400e generally corresponding to switching state 400a and switching state 400f generally corresponding to switching state 400b.

FIG. 4D illustrates a fourth switching mode in which a rectifier stage is used as a switched capacitor booster, the fourth switching mode having a first switching state 400g and a second switching state 400h. The fourth switching mode can be characterized by the way the primary winding of transformer 415 is short circuited, i.e., by closing contactor 451 while opening switches all of switches SaP, SaN, SbQ, and SbN. Contactor 451 can be a mechanical contactor, although for typical relatively higher PWM switching frequencies, a solid-state contactor arrangement may be preferred. Otherwise, the DC side operation of the third switching mode can be as generally as described above with respect to the first switching mode, with switching state 400g generally corresponding to switching state 400a and switching state 400h generally corresponding to switching state 400b.

FIG. 4E illustrates a fifth switching mode in which a rectifier stage is used as a switched capacitor booster, the fifth switching mode having a first switching state 400i and a second switching state 400j. The fifth switching mode can be characterized by the way transformer 415 is short circuited, i.e., by shorting the secondary winding (as opposed to the primary winding) by closing contactor 452 while opening switches all of switches SaP, SaN, SbQ, and SbN. Contactor 452 can be a mechanical contactor, although for typical relatively higher PWM switching frequencies, a solid-state contactor arrangement may be preferred. Additionally, because the secondary winding of transformer 415 is short circuited, the inherent leakage inductance of transformer 415 may not be available to achieve soft switching as was described above. Thus, it may be desirable to provide a discrete “leakage” inductor Llkg/414 to provide this inductance. Otherwise, the DC side operation of the third switching mode can be as generally as described above with respect to the first switching mode, with switching state 400i generally corresponding to switching state 400a and switching state 400j generally corresponding to switching state 400b.

FIG. 4F illustrates a sixth switching mode in which a rectifier stage is used as a switched capacitor booster, the sixth switching mode having a first switching state 400k and a second switching state 400l. The sixth switching mode can be characterized by the way the primary winding of transformer 415 is short circuited. More specifically, the sixth switching mode can be implemented in a system in which AC charging is provided by a wireless (inductive) power system. In such wireless power transfer systems, the wireless power transmitter coil and wireless power receiver coil are mutually coupled inductors forming what is effectively a loosely coupled transformer. If the wireless power transmitter is absent, the wireless power receiver coil 415 effectively becomes an inductor whose inductance can fill the role of leakage inductance Llkg/414. Otherwise, the DC side operation of the third switching mode can be as generally as described above with respect to the first switching mode, with switching state 400k generally corresponding to switching state 400a and switching state 400l generally corresponding to switching state 400b.

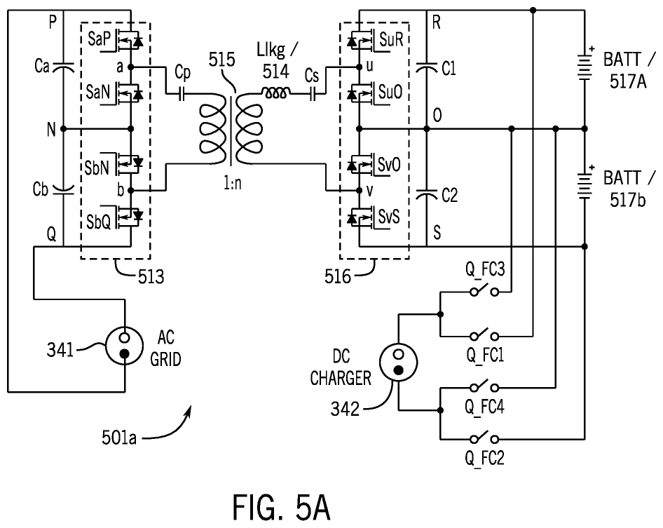

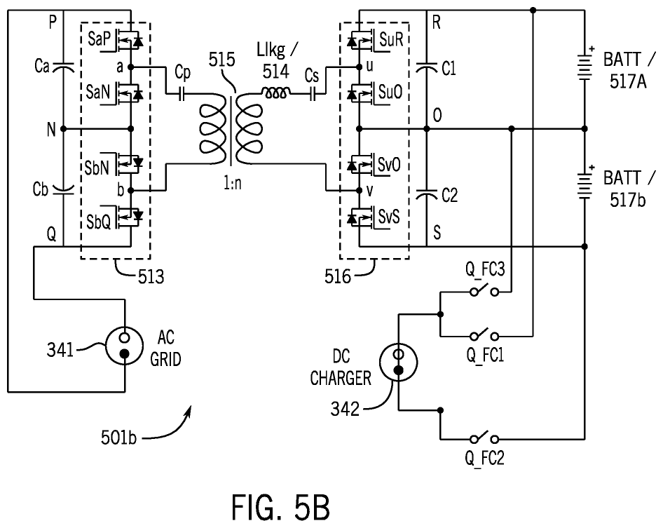

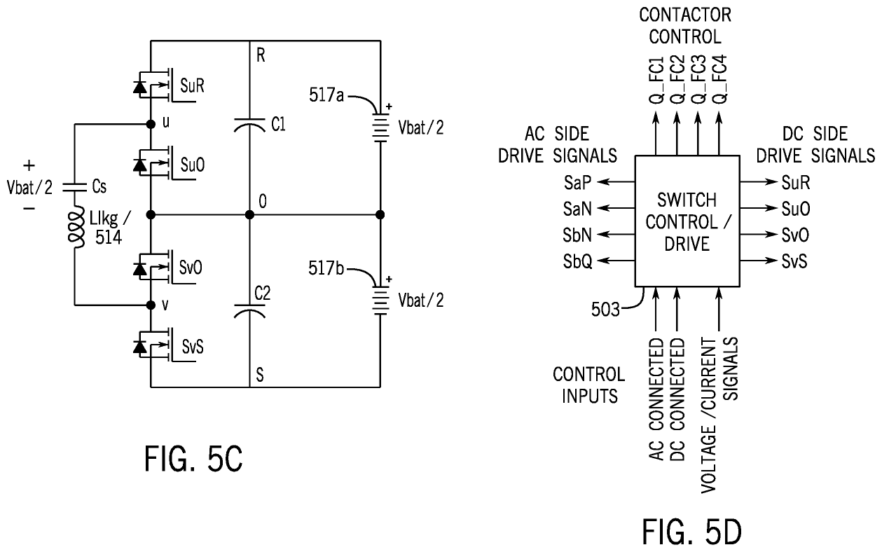

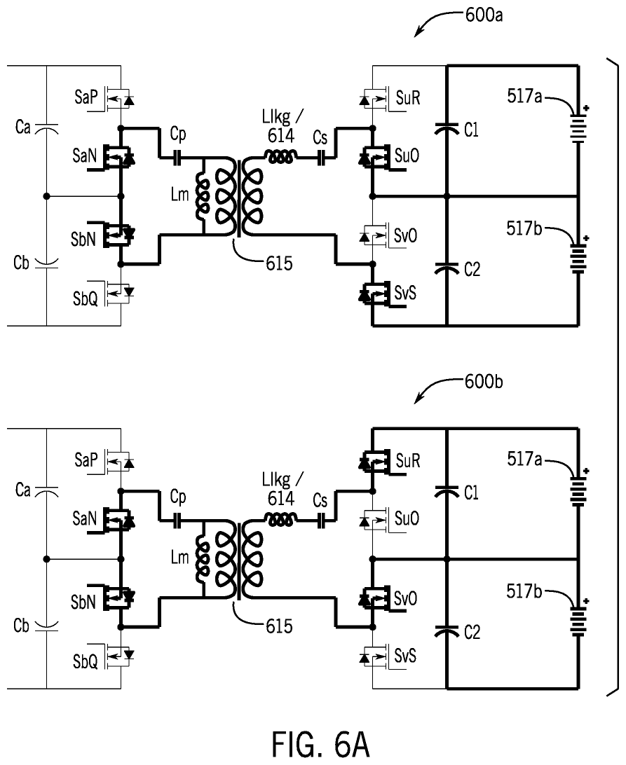

FIG. 5A illustrates an improved arrangement 501a for charging a dual battery system from either an AC grid 341 or a DC charger 342 in which a rectifier stage 516 can be used as a switched capacitor balancer. Beginning on the AC side of circuit arrangement 501a, AC grid 341 is coupled to inverter 513, which can generally correspond to inverter 113/123/213/313 as described above. Inverter 513 can be a stacked half bridge topology including a first half bridge and a second half bridge. The first half bridge can include switches SaP and SaN connected as shown between AC line P and neutral N. The second half bridge can include switches SbN and SbQ connected as shown between AC line Q and neutral N. Input capacitors Ca and Cb can be coupled across the respective half bridges.

The switch node of the first half bridge (i.e., node a) can be coupled to the primary winding of transformer 515 via a blocking capacitor Cp. Similarly, the switch node of the second half bridge (i.e., node b) can also be coupled to the primary winding of transformer 515. Transformer 515 can have a turns ratio of 1:n to produce a desired output voltage. Transformer 515 can also include a leakage inductance Llkg/514, represented schematically as shown, although this need not be a discrete inductor but rather a property of the transformer itself. Alternatively, in some embodiments, a discrete “leakage” inductor can be provided if necessary to supply a desired inductance.

The secondary winding of transformer 515 can be coupled to rectifier 516, which can generally correspond to rectifier 116/126/216/316 as described above. More specifically, rectifier 516 can be constructed using a stacked half bridge topology, with a first half bridge and a second half bridge. The first half bridge can include switches SuR and SuO connected between the positive terminal R of first battery 517a and midpoint terminal O coupled to the negative terminal of first battery 517b as shown. The second half bridge can include switches SvO and SvS connected between midpoint terminal O, also coupled to the positive terminal of second battery 517b and the negative battery terminal S of second battery 517b as shown. The switch node u of the first half bridge can be coupled to the secondary winding of transformer 515 via blocking capacitor Cs (and leakage inductance Llkg/514, although, as noted, the leakage inductance need not be a discrete component). Similarly, the switch node v of the second half bridge can also be coupled to the secondary winding of transformer 515. Filter capacitors C1 and C2 may be connected across the DC sides of the rectifier half bridges as illustrated.

With continued reference to the DC side of circuit arrangement 501a, a DC charger 342 can be selectively coupled to batteries 517a and 517b via contactors Q_FC1, Q_FC2, Q_FC3, and Q_FC4, which can generally correspond to the contactor discussed above with respect to FIG. 2, although it will be noted that a contactor is provided for each battery connection. If DC charger 342 can provide a DC voltage high enough to charge batteries 517a and 517b in series, then Q_FC1 and Q_FC2 can be closed (with Q_FC3 and Q_FC4 open), allowing for direct DC charging. Otherwise, if DC charger 342 provides a voltage lower than that needed to charge batteries 517a and 517b in series, then one respective pair of contactors can be charged to charge one of the batteries, with the other battery charged by the balancer circuitry as described in greater detail below. Respective contactor pairs in this context include contactors Q_FC1 and Q_FC4 for battery 517a and contactors Q_FC2 and Q_FC3 for battery 517b.

FIG. 5B illustrates an alternative configuration 501b of improved arrangement for charging a dual battery system from either an AC grid 341 or a DC charger 342 in which a rectifier stage 516 can be used as a switched capacitor balancer. Beginning on the AC side of circuit arrangement 501a, AC grid 341 is coupled to inverter 513, which can generally correspond to inverter 113/123/213/313 as described above. Inverter 513 can be a stacked half bridge topology including a first half bridge and a second half bridge. The first half bridge can include switches SaP and SaN connected as shown between AC line P and neutral N. The second half bridge can include switches SbN and SbQ connected as shown between AC line Q and neutral N. Input capacitors Ca and Cb can be coupled across the respective half bridges.

The switch node of the first half bridge (i.e., node a) can be coupled to the primary winding of transformer 515 via a blocking capacitor Cp. Similarly, the switch node of the second half bridge (i.e., node b) can also be coupled to the primary winding of transformer 515. Transformer 515 can have a turns ratio of 1:n to produce a desired output voltage. Transformer 515 can also include a leakage inductance Llkg/514, represented schematically as shown, although this need not be a discrete inductor but rather a property of the transformer itself. Alternatively, in some embodiments, a discrete “leakage” inductor can be provided if necessary to supply a desired inductance.

The secondary winding of transformer 515 can be coupled to rectifier 516, which can generally correspond to rectifier 116/126/216/316 as described above. More specifically, rectifier 516 can be constructed using a stacked half bridge topology, with a first half bridge and a second half bridge. The first half bridge can include switches SuR and SuO connected between the positive terminal R of first battery 517a and midpoint terminal O coupled to the negative terminal of first battery 517b as shown. The second half bridge can include switches SvO and SvS connected between midpoint terminal O, also coupled to the positive terminal of second battery 517b and the negative battery terminal S of second battery 517b as shown. The switch node u of the first half bridge can be coupled to the secondary winding of transformer 515 via blocking capacitor Cs (and leakage inductance Llkg/514, although, as noted, the leakage inductance need not be a discrete component). Similarly, the switch node v of the second half bridge can also be coupled to the secondary winding of transformer 515. Filter capacitors C1 and C2 may be connected across the DC sides of the rectifier half bridges as illustrated.

With continued reference to the DC side of circuit arrangement 501b, a DC charger 342 can be selectively coupled to batteries 517a and 517b via contactors Q_FC1, Q_FC2, and Q_FC3, which can generally correspond to the contactor arrangement discussed above with respect to FIG. 5A, although it will be noted because contactors Q_FC3 and Q_FC4 coupled the same nodes, one of them (e.g., contactor Q_FC4) can be eliminated. If DC charger 342 can provide a DC voltage high enough to charge batteries 517a and 517b in series, then Q_FC1 and Q_FC2 can be closed (with Q_FC3 open), allowing for direct DC charging. Otherwise, if DC charger 342 provides a voltage lower than that needed to charge batteries 517a and 517b in series, then one respective pair of contactors can be charged to charge one of the batteries, with the other battery charged by the balancer circuitry as described in greater detail below. Respective contactor pairs in this context means contactors Q_FC3 and Q_FC2 for battery 517b, with battery 517a being charged by the balancer as described in greater detail below.

FIG. 5C illustrates an equivalent circuit 502 of the rectifier stage 316 used as a switched capacitor balancer. The DC charger connection has been omitted from FIG. 5C for brevity. In this mode, the primary winding of transformer 515 can be short circuited by various means (described in greater detail below), so that the DC side of the circuit functions as a switched capacitor balancer. More specifically, rectifier switching devices SuR, SuO, SvO, and SvS can be operated by control circuitry 503 to selectively couple blocking capacitor Cs, which acts as the flying capacitor of the switched capacitor booster, in parallel with the source battery, thereby charging the capacitor, and in series with the source battery and in parallel with the sink battery, thereby discharging the capacitor into the sink battery. In this context, “source battery” refers to the battery from which charge is being transferred, i.e., the battery with the higher state of charge, and “sink battery” means the battery to which charge is being transferred, i.e., the battery with the lower state of charge. Basic operation of switched capacitor converters is known to those skilled in the art, and results in an average voltage of approximately Vbat/2 across the flying capacitor Cs. In series with the source battery, which can also provide a voltage of approximately Vbat/2, this provides a voltage Vbat, suitable for charging the series combination of batteries 517a/517b.

FIG. 5D illustrates control circuitry 503 of an improved arrangement for charging a dual battery system from either an AC grid 341 or a DC charger 342 in which a rectifier stage 516 can be used as a switched capacitor balancer. Control circuitry 503 can be implemented using any suitable combination of analog, digital, or programmable circuitry, implementing such functions as error amplifiers, comparators, logic gates, delays, storage, programmable functionality, microcontrollers, microprocessors, etc. This circuitry can be implemented using any suitable combination of discrete circuit elements, integrated circuits, etc. Control circuitry 503 can receive a variety of inputs, including indications whether the AC charging circuitry is connected to an AC grid 341, whether the DC charging circuitry is connected to a DC charger 342, and voltage/current signals, such as the voltage of the supplied AC and/or DC voltages and/or supplied or available input currents; output voltages and supplied, required, or desired output currents; and one or more intermediate voltages, currents, or other signals (temperature, etc.). Although described as a single controller, control circuitry 503 could be implemented as multiple controllers each providing certain functionality. In such cases, communication between the various control circuits/controllers can be provided as necessary or desirable to provide the desired overall operation and/or the various separate control circuits can operate independently to the extent possible or desirable.

Control circuitry 503 can also implement one or more control loops and/or program logic to generate the signals needed to control various components of the system. For example, AC side drive signals may be provided to control the operation of switches SaP, SaN, SbN, and SbQ depending on the operating mode and other parameters. For example, when charging from an AC source 341 these switches can be operated to provide a desired voltage to transformer 515 corresponding to a desired battery charging voltage. When charging from a DC charger 342 that can supply an adequate voltage to charge the battery, these switches can be turned off. When charging from a DC charger 342 that cannot supply an adequate voltage to charge batteries 517a and 517b in series, these switches can be operated to short circuit the primary winding of transformer 515 as described in greater detail below.

Likewise, control circuitry 503 can provide DC side control/drive signals to control the operation of switches SuR, SuO, SvO, and SvS depending on the operating mode and other parameters. For example, when charging from an AC source 541, these switches can be operated as an active rectifier to produce a DC charging voltage from the AC voltage appearing across the secondary winding of transformer 515. When charging from a DC charger 342 that can supply an adequate voltage to charge batteries 517a and 517b in series, these switches can be turned off. When charging from a DC charger 342 that cannot supply an adequate voltage to charge the battery, these switches can be operated to act as a switched capacitor converter as described in greater detail below.

Additionally, control circuitry 503 can provide contactor control signals Q_FC1, Q_FC2, and Q_FC3 (as well as optional contactor Q_FC4) to control the contactor described above. For example, when charging from an AC source 341, these contactors can be open. When charging from a DC charger 342 that can supply an adequate voltage to charge batteries 517a and 517b in series, contactors Q_FC1 and Q_FC2 can be closed, as described above. When charging from a DC charger 342 that cannot supply an adequate voltage to charge batteries 571a and 517b, the contactors can be configured to charge one battery, as described above, with the balancer charging the other battery.

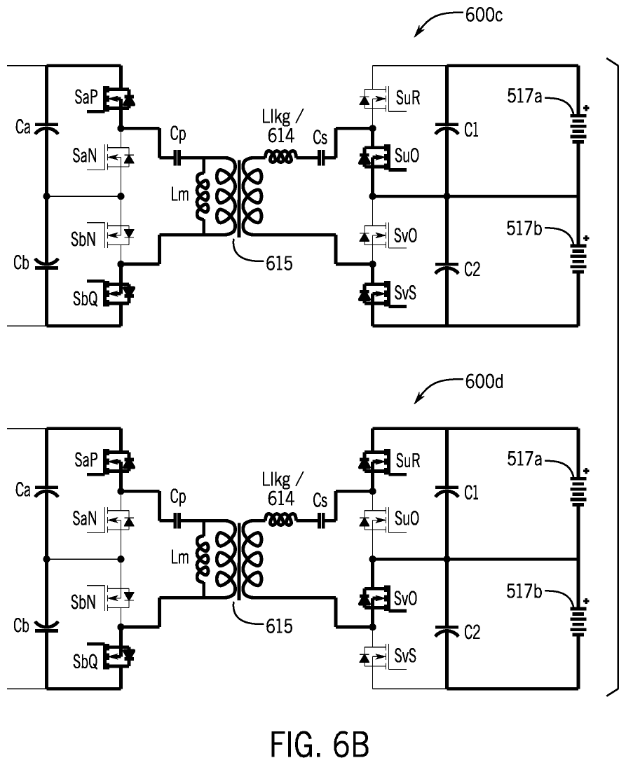

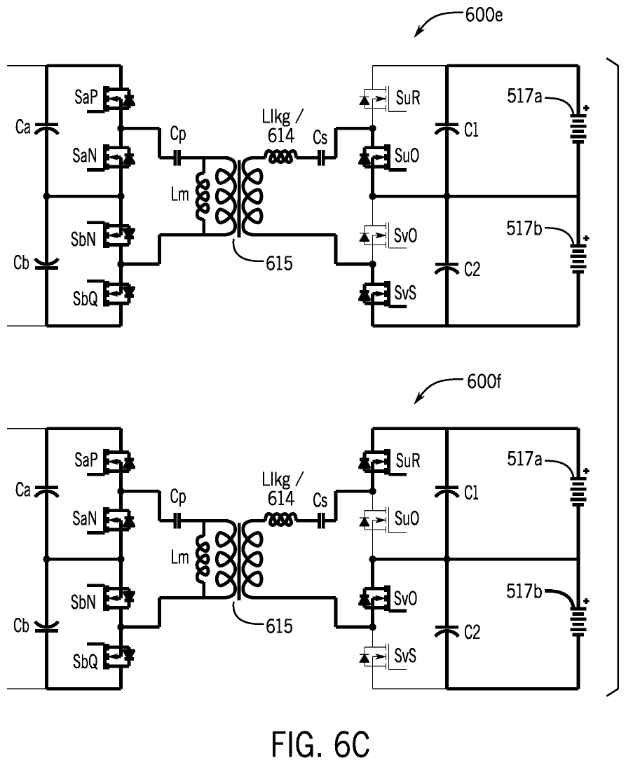

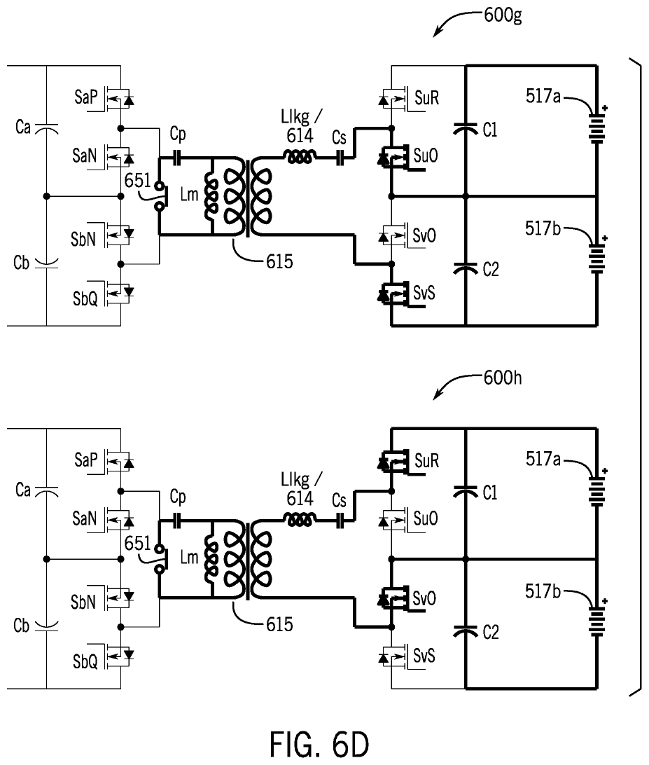

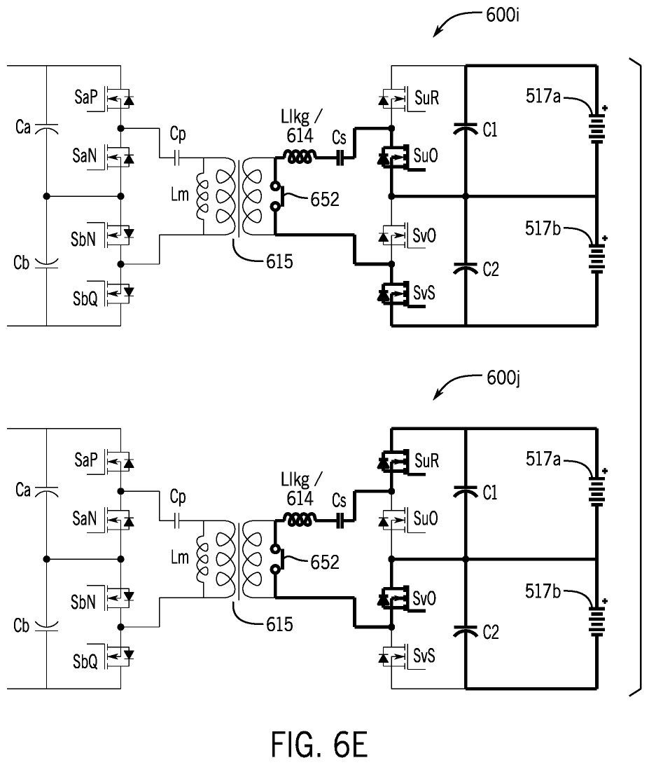

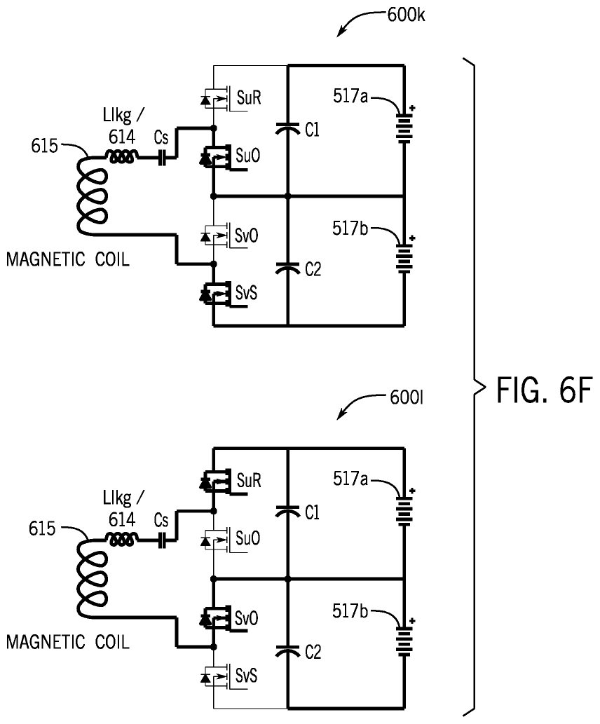

FIG. 6A illustrates a first switching mode in which a rectifier stage is used as a switched capacitor balancer, the first switching mode having a first switching state 600a and a second switching state 600b. The first switching mode can be characterized by the way the primary winding of transformer 615 is short circuited, i.e., by closing switches SaN and SbN while switches SaP and SbQ remain open. Magnetizing inductance Lm of transformer 615 is also depicted for completeness. The following description of the two switching states assumes that battery 517b is the “source” battery, i.e., the battery with the higher voltage/state of charge and that battery 517a is the “sink” battery, i.e., the battery with the lower voltage/state of charge, although the balancer circuit also works in the opposite direction.

In first switching state 600a, switches SuO and SvS are closed, and switches SuR and SvO are opened. This effectively connects flying capacitor Cs (also used as a blocking capacitor in other modes) in parallel with DC charger 442. This allows flying capacitor Cs to charge from the source battery (e.g., battery 517b) to approximately the same voltage as the source battery. Additionally, capacitor C2 is connected in parallel with battery 517b, thus being charged to the same voltage. Capacitor C1 is connected in parallel with battery 517a, thus being charged to the same voltage.

In second switching state 600b, switches SuO and SvS are opened, and switches SuR and SvO are closed. In other words, as between the two switching states, the switches of each half bridge (i.e., switches SuR and SuO of the first half bridge and switches SvO and SvS of the second half bridge) are operated complementarily. This effectively connects flying capacitor Cs (also used as a blocking capacitor in other modes) in series with the source battery (e.g., battery 517b) with the series combination being connected across the series combinations of batteries 517a and 517b. This allows flying capacitor Cs to discharge while suppling twice the input voltage to the battery. Additionally, capacitor C2 is connected in parallel with battery 517b, thus being charged to the same voltage. Capacitor C1, is connected in parallel with battery 517a, and is thus charged to the same voltage. Thus, in second switching state 600b, the series combination the source battery and flying capacitor Cs (and also capacitors C1 and C2) presents the combined series voltage across the series combination of batteries 517a and 517b.

The foregoing description assumes that battery 517b is the “source” and battery 517a is the “sink,” but the reverse could be true. In either case (whether in state 600a or 600b), the flying capacitor Cs will charge when connected in parallel with the source battery, i.e., the battery with the higher voltage, and will discharge when connected in series with the sink battery, i.e., the battery with the lower voltage), thus “balancing” the charge as between the batteries. Alternating between first and second switching states 600a/600b can thus equalize the charge as between the two batteries, thus allowing for a high voltage series combination battery to be charged from a lower voltage DC source without requiring additional balancer circuitry. The frequency/timing of the alternation between the respective switching states can be controlled to achieve soft switching by using the energy stored in leakage inductance Llkg/614, thereby improving the operating efficiency of the circuit.

FIG. 6B illustrates a second switching mode in which a rectifier stage is used as a switched capacitor balancer, the second switching mode having a first switching state 600c and a second switching state 600d. The second switching mode can be characterized by the way the primary winding of transformer 615 is short circuited, i.e., by closing switches SaP and SbQ while switches SaN and SbN remain open. This configuration is complementary to the configuration discussed above with respect to FIG. 6A but is otherwise effectively equivalent at the PWM switching frequency, which can be substantially higher than the AC line frequency. In other words, the relatively large capacitance of input capacitors Ca/Cb can be seen as effectively a short circuit at the higher PWM switching frequency. In some applications it may be desirable to alternate between the first and second switching modes to equalize the thermal load as between the AC side switching devices. The first switching mode may be preferred in some applications, as the second switching mode may energize the AC terminals, which may or may not be appropriate in some applications. Alternatively, additional isolation for the AC input terminals could be provided, for example in the form of an isolation or disconnect switch, which could be implemented as a solid-state and/or mechanical switching arrangement. Otherwise, the DC side operation of the second switching mode can be as generally as described above with respect to the first switching mode, with switching state 600c generally corresponding to switching state 600a and switching state 600d generally corresponding to switching state 600b.

FIG. 6C illustrates a third switching mode in which a rectifier stage is used as a switched capacitor balancer, the third switching mode having a first switching state 600e and a second switching state 600f. The third switching mode can be characterized by the way the primary winding of transformer 615 is short circuited, i.e., by closing switches all of switches SaP, SaN, SbQ, and SbN. This configuration is effectively the combination of the configurations discussed above with respect to FIGS. 6A and 6B but is otherwise effectively equivalent at the PWM switching frequency, which can be substantially higher than the AC line frequency. In other words, the relatively large capacitance of input capacitors Ca/Cb can be seen as effectively a short circuit at the higher PWM switching frequency. In some applications it may be desirable to alternate between the first, second, and/or third switching modes to equalize the thermal load as between the AC side switching devices. The first switching mode may be preferred in some applications, as the second switching mode may energize the AC terminals, which may or may not be appropriate in some applications. Alternatively, additional isolation for the AC input terminals could be provided, for example in the form of an isolation or disconnect switch, which could be implemented as a solid-state and/or mechanical switching arrangement. Otherwise, the DC side operation of the third switching mode can be as generally as described above with respect to the first switching mode, with switching state 600e generally corresponding to switching state 600a and switching state 600f generally corresponding to switching state 600b.

FIG. 6D illustrates a fourth switching mode in which a rectifier stage is used as a switched capacitor balancer, the fourth switching mode having a first switching state 600g and a second switching state 600h. The fourth switching mode can be characterized by the way the primary winding of transformer 615 is short circuited, i.e., by closing contactor 651 while opening switches all of switches SaP, SaN, SbQ, and SbN. Contactor 651 can be a mechanical contactor, although for typical relatively higher PWM switching frequencies, a solid-state contactor arrangement may be preferred. Otherwise, the DC side operation of the third switching mode can be as generally as described above with respect to the first switching mode, with switching state 600g generally corresponding to switching state 600a and switching state 600h generally corresponding to switching state 600b.

FIG. 6E illustrates a fifth switching mode in which a rectifier stage is used as a switched capacitor balancer, the fifth switching mode having a first switching state 600i and a second switching state 600j. The fifth switching mode can be characterized by the way transformer 615 is short circuited, i.e., by shorting the secondary winding (as opposed to the primary winding) by closing contactor 652 while opening switches all of switches SaP, SaN, SbQ, and SbN. Contactor 652 can be a mechanical contactor, although for typical relatively higher PWM switching frequencies, a solid-state contactor arrangement may be preferred. Additionally, because the secondary winding of transformer 615 is short circuited, the inherent leakage inductance of transformer 615 may not be available to achieve soft switching as was described above. Thus, it may be desirable to provide a discrete “leakage” inductor Llkg/614 to provide this inductance. Otherwise, the DC side operation of the third switching mode can be as generally as described above with respect to the first switching mode, with switching state 600i generally corresponding to switching state 600a and switching state 600j generally corresponding to switching state 600b.

FIG. 6F illustrates a sixth switching mode in which a rectifier stage is used as a switched capacitor balancer, the sixth switching mode having a first switching state 600k and a second switching state 600l. The sixth switching mode can be characterized by the way the primary winding of transformer 615 is short circuited. More specifically, the sixth switching mode can be implemented in a system in which AC charging is provided by a wireless (inductive) power system. In such wireless power transfer systems, the wireless power transmitter coil and wireless power receiver coil are mutually coupled inductors forming what is effectively a loosely coupled transformer. If the wireless power transmitter is absent, the wireless power receiver coil 615 effectively becomes an inductor whose inductance can fill the role of leakage inductance Llkg/614. Otherwise, the DC side operation of the third switching mode can be as generally as described above with respect to the first switching mode, with switching state 600k generally corresponding to switching state 600a and switching state 600l generally corresponding to switching state 600b.

The foregoing describes exemplary embodiments of battery charging circuits using a rectifier stage as a balancer or booster. Such configurations may be used in a variety of applications but may be particularly advantageous when used in conjunction with high voltage batteries, such as those used in electric vehicles or grid storage systems. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A battery charging system capable of charging first and second series-connected batteries from an AC source, a first DC source with a higher voltage than the series-connected batteries, and a second DC source having a voltage lower than the series-connected batteries, the battery charging system comprising:
an inverter having an input coupled to the AC source;
a transformer having a primary winding coupled to an output of the inverter and a secondary winding;
a stacked half bridge rectifier having an input coupled to the secondary winding by a blocking capacitor and an output coupled to the battery;
one or more contactors selectively coupling a DC input that receives power from the first or second DC source to the series-connected batteries and a midpoint of the stacked half bridge rectifier; and
control circuitry that selectively operates the one or more contactors and switching devices of the stacked half bridge rectifier as a switched capacitor balancer using the blocking capacitor as a flying capacitor to equalize charge between the first and second series-connected batteries.

2. The battery charging system of claim 1 wherein the inverter is a stacked half bridge inverter, and the control circuitry selectively operates switching devices of the stacked half bridge inverter to short circuit the primary winding of the transformer when operating the stacked half bridge rectifier as a switched capacitor balancer.

3. The battery charging system of claim 2 wherein the control circuitry selectively operates switching devices of the stacked half bridge inverter to short circuit the primary winding of the transformer using a switching mode comprising one or more of:
a first switching mode including closing a lower switch of an upper half bridge and an upper switch of a lower half bridge while opening an upper switch of the upper half bridge and a lower switch of the lower half bridge;
a second switching mode including closing the upper switch of the upper half bridge and the lower switch of the lower half bridge while opening the lower switch of the upper half bridge and the upper switch of the lower half bridge; and
a third switching mode including closing both switches of the upper half bridge and both switches of the lower half bridge.

4. The battery charging system of claim 3 wherein each of the first, second, and third switching modes further comprise alternating between:
a first switching state in which lower switches of the upper and lower half bridges of the rectifier are closed while upper switches of the upper and lower half bridges are opened; and
a second switching state in which upper switches of the upper and lower half bridges of the rectifier are closed;
wherein in one of the first or second switching states the flying capacitor is charged from a battery of the first and second series-connected batteries having a higher state of charge and in another of the first or second switching states the flying capacitor is discharged into a battery of the first and second series-connected batteries having a lower state of charge.

5. The battery charging system of claim 4 wherein a frequency of alternating between the first switching state and the second switching state is controlled to achieve soft switching using energy stored in an inductance that resonates with the flying capacitor.

6. The battery charging system of claim 5 wherein the inductance includes a leakage inductance of the transformer.

7. The battery charging system of claim 5 wherein the inductance includes a discrete inductor.

8. The battery charging system of claim 3 wherein the control circuitry selectively operates switching devices of the stacked half bridge inverter to short circuit the primary winding of the transformer by alternating between two or more of the first, second, or third switching modes.

9. The battery charging system of claim 2 wherein the control circuitry selectively operates a contactor to short circuit a winding of the transformer using a switching mode comprising one or more of:
a fourth switching mode including using a contactor to short circuit a primary winding of the transformer; and
a fifth switching mode including using a contactor to short circuit a secondary winding of the transformer.

10. The battery charging system of claim 9 wherein each of the fourth and fifth switching modes further comprise alternating between:
a first switching state in which lower switches of the upper and lower half bridges of the rectifier are closed while upper switches of the upper and lower half bridges are opened; and
a second switching state in which upper switches of the upper and lower half bridges of the rectifier are closed;
wherein in one of the first or second switching states the flying capacitor is charged from a battery of the first and second series-connected batteries having a higher state of charge and in another of the first or second switching states the flying capacitor is discharged into a battery of the first and second series-connected batteries having a lower state of charge.

11. The battery charging system of claim 2 wherein:
the transformer is a wireless power transfer system, the primary winding is a wireless power transmitter winding, and the secondary winding is a wireless power receiver winding; and
the control circuitry selectively operates in a sixth switching mode comprising alternating between:
a first switching state in which lower switches of the upper and lower half bridges of the rectifier are closed while upper switches of the upper and lower half bridges are opened; and
a second switching state in which upper switches of the upper and lower half bridges of the rectifier are closed;
wherein in one of the first or second switching states the flying capacitor is charged from a battery of the first and second series-connected batteries having a higher state of charge and in another of the first or second switching states the flying capacitor is discharged into a battery of the first and second series-connected batteries having a lower state of charge.

12. A battery charging system comprising:
a stacked half bridge rectifier having an upper half bridge and a lower half bridge;
a blocking capacitor and a winding coupled between a midpoint of the upper half bridge and a midpoint of the lower half bridge;
a battery coupled between an upper terminal of the upper half bridge and a lower terminal of the lower half bridge; and
control circuitry that selectively operates the stacked half bridge rectifier as a switched capacitor converter using the blocking capacitor as a flying capacitor by alternating between:
a first switching state in which lower switches of the upper and lower half bridges of the rectifier are closed while upper switches of the upper and lower half bridges are opened; and
a second switching state in which upper switches of the upper and lower half bridges of the rectifier are closed;
wherein the battery further comprises first and second series-connected batteries having a midpoint coupled to a midpoint of the stacked half bridge rectifier, and the switched capacitor converter operates as a balancer to equalize charge between the first and second series-connected batteries.

13. The battery charging system of claim 12 wherein a frequency of alternating between the first switching state and the second switching state is controlled to achieve soft switching using energy stored in the winding, which resonates with the flying capacitor.

14. The battery charging system of claim 13 wherein the winding is a winding of a transformer.

15. The battery charging system of claim 13 wherein the winding is a wireless power receiver winding.

16. The battery charging system of claim 13 wherein the winding is a discrete inductor.

17. A power converter comprising:
a stacked half bridge converter having an upper half bridge and a lower half bridge;
a capacitor and an inductance coupled between a switch node of the upper half bridge and a switch node of the lower half bridge;
a first output coupled across the upper half bridge and a second output coupled across the lower half bridge; and
control circuitry that selectively operates the stacked half bridge converter as:
a rectifier to produce output DC voltages from an input AC voltage received via the capacitor and inductance; or
a switched capacitor converter using the capacitor as a flying capacitor to balance the output DC voltages by alternating between:
a first switching state in which lower switches of the upper and lower half bridges of the converter are closed while upper switches of the upper and lower half bridges of the converter are opened; and
a second switching state in which upper switches of the upper and lower half bridges of the converter are closed;
wherein the switched capacitor converter operates as a booster to charge the battery from a DC voltage source having a voltage lower than a voltage of the battery.

18. The power converter of claim 17 wherein a frequency of alternating between the first switching state and the second switching state is controlled to achieve soft switching using energy stored in a resonant circuit including the capacitor and the inductance.

19. The power converter of claim 18 wherein the inductance includes a winding of a transformer.

20. The power converter of claim 18 wherein the inductance includes a wireless power receiver winding.

21. The power converter of claim 18 wherein the inductance includes a discrete inductor.
